(19) United States
(12) Patent Application Publication
(10) Pub. No.: US 2021/0405687 A1
(43) Pub. Date: Dec. 30, 2021

(54) DISPLAY EQUIPMENT

(71) Applicant: Shenzhen China Star Optoelectronics Semiconductor Display Technology Co., Ltd., Shenzhen (CN)

(72) Inventors: Jianhong Chen, Shenzhen (CN); Tienchun Huang, Shenzhen (CN)

(73) Assignee: Shenzhen China Star Optoelectronics Semiconductor Display Technology Co., Ltd., Shenzhen (CN)

(21) Appl. No.: 16/638,169

(22) PCT Filed: Dec. 23, 2019
(86) PCT No.: PCT/CN2019/127299

§ 371 Date: Feb. 11, 2020

(30) Foreign Application Priority Data
Dec. 5, 2019 (CN) 201911237220.5

(51) Int. Cl. G06F 1/16; G02F 1/1335; H01L 27/32

(52) U.S. Cl. CPC G06F 1/1603; H01L 27/3223; G02F 1/133612; G06F 1/1635

(57) ABSTRACT

A display equipment is provided. By disposing an anti-peep member in the display equipment, a shielding part disposed on a light exiting surface of a display device reduces viewing angles of the display device in a first state, while the anti-peep member is disposed outside the display device to allow the viewing angles of the display device to recover to conventional viewing angles in a second state. Therefore, the viewing angles of the display device are reduced in the first state, which prevents displayed contents of the display device from being leaked and prevents privacy leakage.

### FIELD OF INVENTION

The present disclosure relates to the field of display technology, and particularly relates to a display equipment.

### BACKGROUND OF INVENTION

Liquid crystal display panels or organic light emitting diode (OLED) display devices are used to manufacture current display devices. Because the liquid crystal display panels and the OLED display panels have wide viewing angles, this makes contents displayed by the display devices be displayed beyond a front view range of the display devices, which causes displayed contents to be disclosed inadvertently when the display devices are used in public and lead to leaked privacy.

Therefore, current display devices have the technical problem of privacy leakage due to wide viewing angles.

### SUMMARY OF INVENTION

The present disclosure provides a display equipment to solve the technical problem of privacy leakage due to current display devices having wide viewing angles.

In order to solve the problems mentioned above, the present disclosure provides the technical solutions as follows:

The present disclosure provides a display equipment, and the display equipment includes:

A display device.

An anti-peep member, which includes a shielding part and a light transmissive part. The shielding part is used to reduce viewing angles of the display device.

Furthermore, the anti-peep member is disposed on a light exiting surface of the display device in a first state, and the anti-peep member is disposed outside the light exiting surface of the display device in a second state.

In the display equipment provided by the present disclosure, the shielding part includes a light absorbing portion, and the light absorbing portion is disposed on an edge of the light exiting surface of the display device in the first state. The light absorbing portion is used to absorb light emitted from the display device.

In the display equipment provided by the present disclosure, a thickness of the light transmissive part is equal to a thickness of the shielding part.

In the display equipment provided by the present disclosure, the shielding part includes a light shielding portion. A cross sectional area of the light transmissive part is greater than or equal to a cross sectional area of the display device. The light shielding portion is disposed on an edge of the light transmissive part, and the light shielding portion surpasses the light transmissive part along the light exiting surface away from the display panel in the first state.

In the display equipment provided by the present disclosure, material of the light transmissive part includes transparent glass.

In the display equipment provided by the present disclosure, the anti-peep member is disposed separately from the display device.

In the display equipment provided by the present disclosure, in the first state, the shielding part includes a first shielding section disposed on a lateral surface of the display device and a second shielding section disposed on an edge of the light exiting surface of the display device.

In the display equipment provided by the present disclosure, the anti-peep member is connected to the display device, and the shielding part is integrated with the light transmissive part.

In the display equipment provided by the present disclosure, the anti-peep member includes a combination part and a connection part. The combination part is connected to the display device and is disposed under a backlight surface of the display device. The connection part is connected to the combination part and the shielding part. The shielding part and the light transmissive part are disposed between the combination part and the display device in the second state.

In the display equipment provided by the present disclosure, the combination part includes an accommodating chamber and a connection component. The connection component is connected to the accommodating chamber, and the connection component is connected to the display device.

In the display equipment provided by the present disclosure, the combination part includes a power source, and the power source is disposed in a middle of the accommodating chamber.

In the display equipment provided by the present disclosure, the power source includes a solar power source.

In the display equipment provided by the present disclosure, the power source is electrically connected to the display device.

In the display equipment provided by the present disclosure, the connection component includes an optically clear adhesive.

In the display equipment provided by the present disclosure, the connection component includes screws, and screw threads matching the screws are disposed on the display device.

In the display equipment provided by the present disclosure, the connection part includes a hinge.

In the display equipment provided by the present disclosure, the anti-peep member further includes a combination part and a connection part. The combination part is connected to the display device and is disposed under a backlight surface of the display device. The connection part is connected to the combination part and the shielding part. In the second state, the shielding part and the light transmissive part are disposed in a direction of the combination part away from the display device.

In the display equipment provided by the present disclosure, the combination part includes a protection section and a connection component, the protection section is bonded and disposed on the backlight surface of the display device, and the connection component is connected to the protection section and the display device.

In the display equipment provided by the present disclosure, the display device includes a liquid crystal display panel and a backlight module.

In the display equipment provided by the present disclosure, the display device includes an organic light emitting diode display panel.

The present disclosure provides a display equipment. The display equipment includes a display device and an anti-peep member. The anti-peep member includes a shielding part and a light transmissive part. The shielding part is used to reduce viewing angles of the display device. Furthermore, the anti-peep member is disposed on a light exiting surface of the display device in a first state, and the anti-peep member is disposed outside the light exiting surface of the display device in a second state. By disposing the anti-peep member, the shielding part is disposed on the light exiting surface of the display device in the first state, and the shielding part reduces viewing angles of the display device. Meanwhile, the anti-peep member is disposed outside the light exiting surface of the display device in the second state, so that the viewing angles of the display device are recovered to conventional viewing angles. Therefore, this makes the viewing angles of the display device be reduced in the first state, thereby preventing displayed contents of the display device from being leaked and preventing privacy leakage, and solving the technical problem of privacy leakage due to wide viewing angles existing in current display devices.

### DESCRIPTION OF DRAWINGS

FIG. 1 is a first schematic diagram of a display equipment provided by an embodiment of the present disclosure.

FIG. 2 is a second schematic diagram of a display equipment provided by an embodiment of the present disclosure.

FIG. 3 is a third schematic diagram of a display equipment provided by an embodiment of the present disclosure.

FIG. 3 is a fourth schematic diagram of a display equipment provided by an embodiment of the present disclosure.

### DETAILED DESCRIPTION OF PREFERRED EMBODIMENTS

The present disclosure provides a display equipment. For making the purposes, technical solutions and effects of the present disclosure be clearer and more definite, the present disclosure will be further described in detail below. It should be understood that the specific embodiments described herein are merely for explaining the present disclosure and are not intended to limit the present disclosure.

The present disclosure is aimed at the technical problem of privacy leakage due to wide viewing angles existing in current display devices, and embodiments of the present disclosure are used to solve the problem.

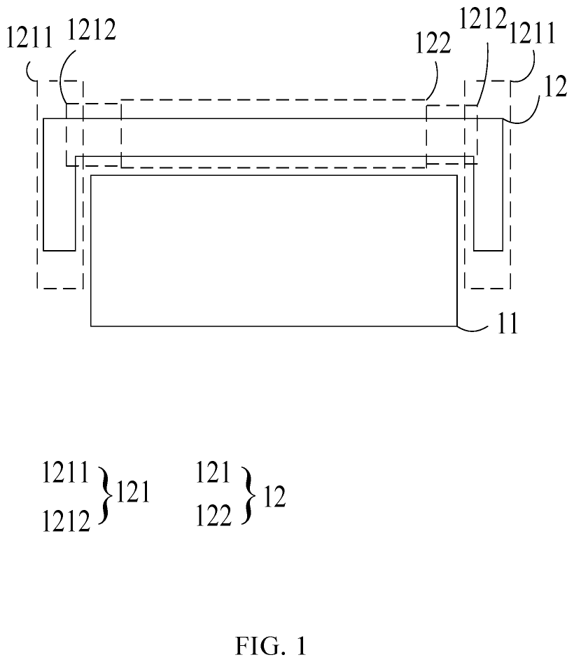

As illustrated in FIG. 1, an embodiment of the present disclosure provides a display equipment, and the display equipment includes:

A display device 11.

An anti-peep member 12, which includes a shielding part 121 and a light transmissive part 122. Furthermore, the shielding part 121 is used to reduce viewing angles of the display device.

Furthermore, the anti-peep member 12 is disposed on a light exiting surface of the display device 11 in a first state, and the anti-peep member 12 is disposed outside the light exiting surface of the display device 11 in a second state.

The present disclosure provides a display equipment. The display equipment includes a display device and an anti-peep member. The anti-peep member includes a shielding part and a light transmissive part. The shielding part is used to reduce viewing angles of the display device. Furthermore, the anti-peep member is disposed on a light exiting surface of the display device in a first state, and the anti-peep member is disposed outside the light exiting surface of the display device in a second state. By disposing the anti-peep member, the shielding part is disposed on the light exiting surface of the display device in the first state, and the shielding part reduces viewing angles of the display device. Meanwhile, the anti-peep member is disposed outside the light exiting surface of the display device in the second state, so that the viewing angles of the display device are recovered to conventional viewing angles. Therefore, this makes the viewing angles of the display device be reduced in the first state, thereby preventing displayed contents of the display device from being leaked and preventing privacy leakage, and solving the technical problem of privacy leakage due to wide viewing angles existing in current display devices.

It should be noted that in the embodiment of the present disclosure, the light exiting surface indicates an outermost film layer penetrated by the light emitted from the display device, the backlight surface indicates an outermost film layer of a back surface of the display device disposed opposite to the light exiting surface, the first state indicates a display state of reducing the viewing angles to protect privacy, and the second state indicates a display state of not processing the viewing angles of the display device so that viewing angles are normal.

In an embodiment, the shielding part includes a light absorbing portion. The light absorbing portion is disposed on an edge of the light exiting surface of the display device in the first state. The light absorbing portion is used to absorb light emitted from the display device. For example, the shielding part 121 in FIG. 1 includes a first shielding section 1211 and a second shielding section 1212. The second shielding section 1212 is disposed on the edge of the light exiting surface of the display device in the first state, and the second shielding section is the light absorbing portion. The light absorbing portion enables absorption of light emitted from the display device on the edge of the display device; thereby, light cannot diffuse toward two sides of the display device, and the viewing angles of the display device are reduced.

In an embodiment, the light absorbing portion can be manufactured by using light absorbing materials; for example, using materials that can absorb blue light or ultraviolet light, such as a blue light absorbent or an ultraviolet light absorbent. Furthermore, the blue light absorbent includes iron oxide, xanthophyll, or lead sulfochromate yellow (CrO₅Pb₂), and the ultraviolet light absorbent includes benzophenone, o-aminobenzoic acid salts, or dibenzoylmethane.

In an embodiment, the light absorbing portion can determine intensity of absorbed light according to a requirement. For example, part of the light can be absorbed, and other part of the light is allowed to pass through, so that at while reducing the viewing angles, this position is still able to display normally in the front view direction of the light exiting surface.

In an embodiment, a thickness of the light transmissive part is same as a thickness of the shielding part. When disposing the anti-peep member, the shielding part and the light transmissive part can be spliced to form the anti-peep member. Therefore, when forming the shielding part, a size of the shielding part is determined according to different viewing angles of different display equipment, while the thicknesses of the light transmissive part and the shielding part are consistent, and a splicing seam of the anti-peep member formed by splicing does not affect display, which makes the anti-peep member on the light exiting surface of the display device be flat. Therefore, when displaying, the display screen is a complete display screen, and problems such as fragmentation or fold marks do not occur on the display screen.

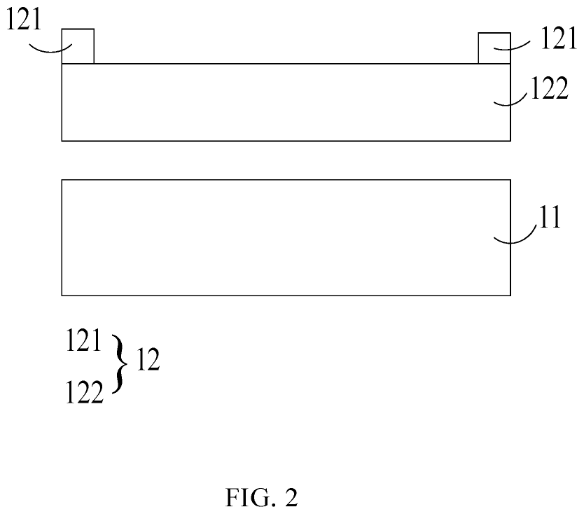

In an embodiment, as illustrated in FIG. 2, the shielding part 121 includes a light shielding portion. A cross sectional area of the light transmissive part 122 is greater than or equal to a cross sectional area of the display device 11. The light shielding portion is disposed on an edge of the light transmissive part 122, and the light shielding portion surpasses the light transmissive part 122 along the light exiting surface away from the display panel in the first state. When disposing the shielding part, the light shielding portion can be directly disposed on the display device, so that the light emitted from the display device cannot diffuse to the two sides of the display device from the light shielding portion. Therefore, this allows the light of the display device to only be emitted from the front of the display device and is not diffused towards the surrounding, so the viewing angles of the display device are reduced. Meanwhile, when making the light shielding portion surpass the light transmissive part, a height of the light shielding portion can be determined according to viewing angles required to be shielded. That is, when larger viewing angles need to be shielded, the light shielding portion is made to be higher, and when smaller viewing angles need to be shielded, the light shielding portion is made to be lower. Meanwhile, when determining the cross sectional area of the light transmissive part, the cross sectional area of the light transmissive part is made to be slightly greater than the cross sectional area of the display device. Therefore, this makes the light shielding portion be located outside the display device, and the display device can normally display entire images, while the light emitted around from the display device is shielded, so the viewing angles of the display device are reduced without affecting displayed images. It should be noted that when the cross sectional area of the light transmissive part is equal to the cross sectional area of the display device, a width of the light shielding portion is required to be small to minimize shielding of the light shielding portion on images displayed at the front, so as to not affect normal display.

In an embodiment, the light shielding portion includes a light shielding material.

In an embodiment, a material of the light transmissive part includes transparent glass. When manufacturing the anti-peep member, transparent glass or transparent plastic are used as the material of the light transmissive part. Afterwards, when manufacturing the shielding part, a groove can be dug at the edge of the light transmissive part, and the shielding part can be disposed inside the light transmissive part. Or, the light transmissive part is disposed, and the shielding part is disposed on the light transmissive part. In consideration for the light transmissive part to not affect display effect, the material of the light transmissive part can be same as a material of a cover plate of the display device, so that the light passes through well, and the display effect is not affected.

In an embodiment, as illustrated in FIG. 1, the anti-peep member 12 and the display device 11 are disposed separately from each other. Disposing the anti-peep member 12 and the display device 11 separately from each other makes the anti-peep member be placed on the light exiting surface of the display device in the first state, and the anti-peep member is taken off from the display device in the second state. Therefore, this ensures that the viewing angles of the display device are reduced in the first state to protect privacy, and the display device is unaffected in the second state.

In an embodiment, as illustrated in FIG. 1, the shielding part 121 includes a first shielding section 1211 disposed on a lateral surface of the display device 11 and a second shielding section 1212 disposed on the edge of the light exiting surface of the display device 11. When the display device and the anti-peep member are disposed separately from each other, the shielding part is made to include the first shielding section located on the lateral surface of the display device, so that the first shielding section can ensure general components can well coordinate with the display panel. Meanwhile, the first shielding section may also have a positioning effect on the coordination between the display device and the anti-peep member. When the first shielding section is located on the two sides of the display device, it does not need to be aligned additionally, and the light transmissive part and the second shielding section are disposed on corresponding positions on the light exiting surface of the display device. Moreover, the first shielding section can shield light emitted from the lateral surface of the display device to reduce the viewing angles. Meanwhile, the second shielding section is disposed on the edge of the light exiting surface of the display device, and it can also shield the light diffused on the two sides of the display device, thereby reducing the viewing angles of the display device.

In an embodiment, the first shielding section includes a light shielding portion, and the second shielding section includes a light absorbing portion.

In an embodiment, the anti-peep member is connected to the display device, and the shielding part is integrated with the light transmissive part. By making the anti-peep member be connected to the display device, during changing between the first state and the second state, the anti-peep member connected to the display device is directly moved to the light exiting surface of the display device, or the anti-peep member is removed from the light exiting surface of the display device.

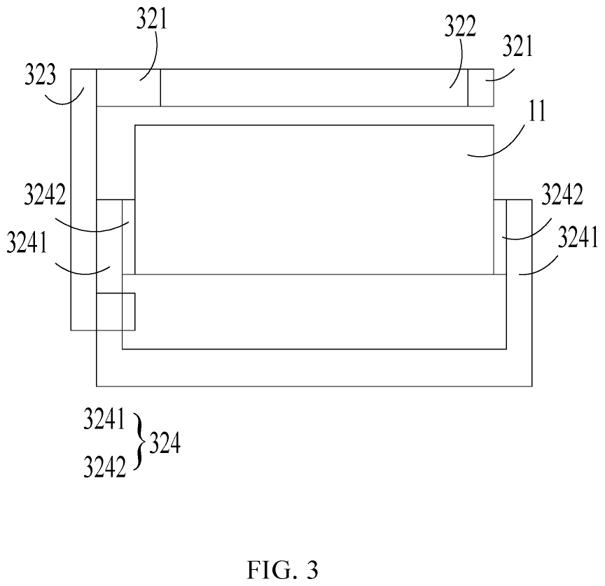

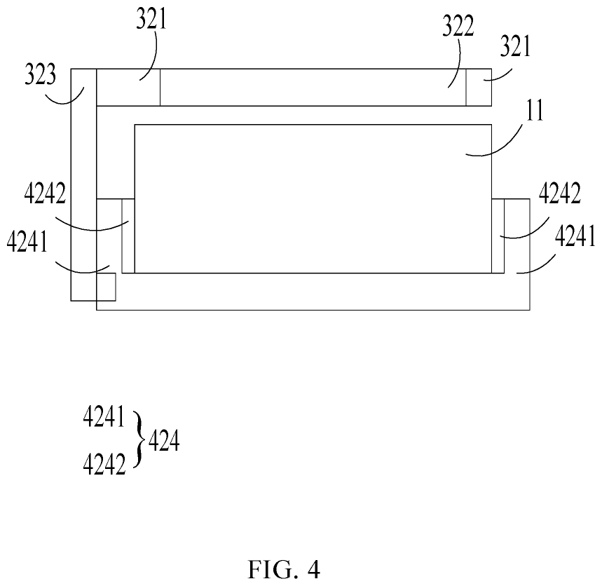

In an embodiment, as illustrated in FIG. 3, the anti-peep member includes a shielding part 321, a light transmissive part 322, a combination part 324, and a connection part 323. The combination part 324 is connected to the display device 11 and is disposed under a backlight surface of the display device 11. The connection part 323 is connected to the combination part 324 and the shielding part 321. The shielding part 321 and the light transmissive part 322 are disposed between the combination part 324 and the display device 11 in the second state, and the combination part has a certain distance from the display device. In the design of the display equipment, the anti-peep member is connected to the display device to bind the anti-peep member on the display device, and by fixing the combination part on a bottom of the display device and connecting the combination part and the shielding part by the connection part, the shielding part and the light transmissive part can be disposed between the combination part and the display device in the second state, thereby making the anti-peep member hang on the lateral surface and the bottom surface of the display device and have no effect on the normal display of the display device. Furthermore, the shielding part and the light transmissive part are moved to the light exiting surface of the display device by the connection part in the first state, so that the shielding part shields the light of the display device, thereby reducing the viewing angles of the display device and preventing privacy leakage.

In an embodiment, the connection part and the light transmissive part are integrated into one piece, and then the shielding part is formed on the light transmissive part. The connection part and the light transmissive part can be formed by using transparent glass or transparent plastic, after that, the shielding part and the light transmissive part can be connected to the combination part by the connection part, so that the shielding part and the light transmissive part can be disposed between the display device and the combination part.

In an embodiment, as illustrated in FIG. 3, the combination part 324 includes an accommodating chamber 3241 and the connection component 3242. The connection component 3242 is connected to the accommodating chamber 3241, and the connection component 3242 is connected to the display device 11. The shielding part and the light transmissive part can be moved into the accommodating chamber around the display device by the connection part in the second state, while the shielding part and the light transmissive part can be moved out from the accommodating chamber in the first state. The connection component makes the combination part be fixed on the display device, so that the anti-peep member is connected to the display device.

In an embodiment, the combination part further includes a power source. The power source is disposed in a middle of the accommodating chamber. Disposing the power source in the combination part can supply electricity to the connection part by the power source, so that the connection part controls movement of the shielding part and the light transmissive part, thereby allowing the anti-peep member to reduce the viewing angles of the display device in the first state, while the viewing angles of the display device are not affected in the second state. Or, the power source can supply a voltage to the display device to make the display device display.

In an embodiment, the power source includes a solar power source, which is charged by solar power and can save resources, and reduces charging difficulty and charging cost. Of course, the power source may also be a general charging power source, and the power source can be charged by disposing a charging port on the combination part.

In an embodiment, the power source is electrically connected to the display device, and the power source acts as a power supply of the display device, or the power source acts as a power supply of the connection part, so that the power source is electrically connected to the display device. This enables the power source to drive a driving circuit of the display device, thereby making the display device emit light to display, and can also allow the power source to provide electricity to the connection part to allow the connection part to guide the movement of the shielding part and the light transmissive part.

In an embodiment, the connection component includes an optically clear adhesive. In the anti-peep member of the display device, the optically clear adhesive is directly disposed in the anti-peep member. By using the optically clear adhesive to bond the anti-peep member onto the display device, the display device structure does not need to be changed.

In an embodiment, the connection component includes screws, and screw threads matching the screws are disposed on the display device. In the cooperating composition of the combination part and the display device, the screw threads may be formed on the lateral surface of the display device first, and then the screws are disposed on the anti-peep member. By matching the screws and the screw threads to each other, the display device and the anti-peep member have a tight connection, and forming the screw threads on the lateral surface of the display device would not have an effect on the display of the display device.

In an embodiment, the connection part includes a hinge. When the connection part is guiding the shielding part and the light transmissive part, the shielding part and the light transmissive part can be guided by manually rotating the connection part, or the circuit-driven hinge can guide the shielding part and light transmissive part, or a bending arm structure may act as the connection part, so the bending arm structure can be made to rotate around the display device under power supplied by the power source and driving of the circuit to guide the shielding part and the light transmissive part to move.

In an embodiment, as illustrated in FIG. 4, the anti-peep member further includes a combination part 424 and a connection part 323. The combination part 424 is connected to the display device 11 and is disposed under a backlight surface of the display device 11. The connection part 323 is connected to the combination part 424 and the shielding part 321. In the second state, the shielding part 321 and the light transmissive part 322 are disposed in a direction of the combination part 424 away from the display device 11. When connecting the anti-peep member and the display device, the combination part is bonded to the backlight surface of the display device to reduce the thickness, while the shielding part and the light transmissive part of the anti-peep member are disposed under a bottom of the combination part in the second state by rotating. This allows the shielding part to be flipped onto the light exiting surface of the display device from the bottom of the display device to reduce the viewing angles of the display device, or the shielding part is moved to the bottom surface of the display device from the light exiting surface of the display device, and normal display is not affected.

In an embodiment, as illustrated in FIG. 4, the combination part 424 includes a protection section 4241 and a connection component 4242. The protection section is bonded on the display device and can protect the display device, while the connection component can make the anti-peep member connect to the display device. Furthermore, the connection component may include an optically clear adhesive, or screws. When the connection component includes screws, screw threads matching the screws are disposed on the display device.

In an embodiment, the display device includes a liquid crystal display panel and a backlight module. The liquid crystal display panel includes an array substrate, a color film substrate, and a touch layer disposed between the array substrate and the color film substrate, or the liquid crystal display panel includes a color-on-array substrate (COA substrate, a color film layer disposed on an array substrate), a liquid crystal layer disposed on the COA substrate, and a common electrode layer and a black matrix layer disposed on the liquid crystal layer. Furthermore, the array substrate includes a base, a buffer layer, an active layer, a first gate insulating layer, a first metal layer, a second gate insulating layer, a second metal layer, an interlayer insulation layer, a source/drain electrode layer, a planarization layer, and a pixel electrode layer. The liquid crystal layer includes a first alignment layer, liquid crystals, and a second alignment layer. The color film substrate includes a common electrode layer, a black matrix layer, a color resist layer, and a base. The backlight module includes an edge-lit light source or a direct-lit light source, and an optical diaphragm.

In an embodiment, the display device includes an organic light emitting diode display panel. The organic light emitting diode display panel includes a base, a buffer layer, an active layer, a first gate insulating layer, a first metal layer, a second gate insulating layer, a second metal layer, an interlayer insulation layer, a source/drain electrode layer, a planarization layer, a pixel electrode layer, a pixel definition layer, and a hole injection layer, a hole transport layer, a luminescent material layer, an electron transport layer, and an electron injection layer, which are disposed in a pixel region defined by the pixel definition layer, and a common electrode layer disposed on the pixel definition layer.

In an embodiment, the display device further includes a touch panel. The touch panel includes an add-on touch panel, an in-cell touch panel (disposing a touch layer in the display panel), or an on-cell touch panel (disposing a touch layer on the display panel).

In an embodiment, the display device further includes a cover plate and an optically clear adhesive located between the cover plate and the display panel.

According to embodiments mentioned above:

The present disclosure provides a display equipment. The display equipment includes a display device and an anti-peep member. The anti-peep member includes a shielding part and a light transmissive part. The shielding part is used to reduce viewing angles of the display device. Furthermore, the anti-peep member is disposed on a light exiting surface of the display device in a first state, and the anti-peep member is disposed outside the light exiting surface of the display device in a second state. By disposing the anti-peep member, the shielding part is disposed on the light exiting surface of the display device in the first state, and the shielding part reduces viewing angles of the display device. Meanwhile, the anti-peep member is disposed outside the light exiting surface of the display device in the second state, so that the viewing angles of the display device are recovered to conventional viewing angles. Therefore, this makes the viewing angles of the display device be reduced in the first state, thereby preventing displayed contents of the display device from being leaked and preventing privacy leakage, and solving the technical problem of privacy leakage due to wide viewing angles existing in current display devices.

It can be understood, that for those of ordinary skill in the art, various other corresponding changes and modifications can be made according to the technical solutions and technical ideas of the present disclosure, and all such changes and modifications are intended to fall within the scope of protection of the claims of the present disclosure.

What is claimed is:

1. A display equipment, comprising:
a display device; and
an anti-peep member comprising a shielding part and a light transmissive part, wherein the shielding part is used to reduce viewing angles of the display device; and
wherein the anti-peep member is disposed on a light exiting surface of the display device in a first state, and the anti-peep member is disposed outside the light exiting surface of the display device in a second state.

2. The display device as claimed in claim 1, wherein the shielding part comprises a light absorbing portion, the light absorbing portion is disposed on an edge of the light exiting surface of the display device in the first state, and the light absorbing portion is used to absorb light emitted from the display device.

3. The display equipment as claimed in claim 2, wherein a thickness of the light transmissive part is equal to a thickness of the shielding part.

4. The display equipment as claimed in claim 1, wherein the shielding part comprises a light shielding portion, a cross sectional area of the light transmissive part is greater than or equal to a cross sectional area of the display device, the light shielding portion is disposed on an edge of the light transmissive part, and the light shielding portion surpasses the light transmissive part along the light exiting surface away from the display panel in the first state.

5. The display equipment as claimed in claim 1, wherein a material of the light transmissive part comprises transparent glass.

6. The display equipment as claimed in claim 1, wherein the anti-peep member is disposed separately from the display device.

7. The display equipment as claimed in claim 6, wherein in the first state, the shielding part comprises a first shielding section disposed on a lateral surface of the display device and a second shielding section disposed on an edge of the light exiting surface of the display device.

8. The display equipment as claimed in claim 1, wherein the anti-peep member is connected to the display device, and the shielding part is integrated with the light transmissive part.

9. The display equipment as claimed in claim 8, wherein the anti-peep member comprises a combination part and a connection part, the combination part is connected to the display device and is disposed under a backlight surface of the display device, the connection part is connected to the combination part and the shielding part, and the shielding part and the light transmissive part are disposed between the combination part and the display device in the second state.

10. The display equipment as claimed in claim 9, wherein the combination part comprises an accommodating chamber and a connection component, the connection component is connected to the accommodating chamber, and the connection component is connected to the display device.

11. The display equipment as claimed in claim 10, wherein the combination part comprises a power source, and the power source is disposed in a middle of the accommodating chamber.

12. The display equipment as claimed in claim 11, wherein the power source comprises a solar power source.

13. The display equipment as claimed in claim 11, wherein the power source is electrically connected to the display device.

14. The display equipment as claimed in claim 10, wherein the connection component comprises an optically clear adhesive.

15. The display equipment as claimed in claim 10, wherein the connection component comprises screws, and screw threads matching the screws are disposed on the display device.

16. The display equipment as claimed in claim 9, wherein the connection part comprises a hinge.

17. The display equipment as claimed in claim 8, wherein the anti-peep member comprises a combination part and a connection part, the combination part is connected to the display device and is disposed under a backlight surface of the display device, the connection part is connected to the combination part and the shielding part, and in the second state, the shielding part and the light transmissive part are disposed in a direction of the combination part away from the display device.

18. The display equipment as claimed in claim 17, wherein the combination part comprises a protection section and a connection component, the protection section is bonded and disposed on the backlight surface of the display device, and the connection component is connected to the protection section and the display device.

19. The display equipment as claimed in claim 1, wherein the display device comprises a liquid crystal display panel and a backlight module.

20. The display equipment as claimed in claim 1, wherein the display device comprises an organic light emitting diode display panel.
